(19) United States
(12) Patent Application Publication
(10) Pub. No.: US 2008/0223217 A1
(43) Pub. Date: Sep. 18, 2008

(54) Brewing System and Methods

(75) Inventors: William J. Teller, Springfield, IL (US); Eugene R. Kief, Reno, NV (US)

Correspondence Address: BACHMAN & LAPOINTE, P.C. (UTC), 900 CHAPEL STREET, SUITE 1201, NEW HAVEN, CT, 06510-2802, US

(73) Assignee: CARRIER COMMERCIAL REFRIGERATION, INC., Charlotte, NC (US)

(21) Appl. No.: 11/997,331

(22) PCT Filed: Sep. 29, 2005
(86) PCT No.: PCT/US05/35255

§ 371 Date: Jan. 30, 2008

(51) Int. Cl. A47J 31/00

(52) U.S. Cl. 99/280

(57) ABSTRACT

A brewing system (20) may utilize first (24) and second (26) structurally different funnels. The first funnel (24) has surfaces (31, 37) positioned for carrying an upwardly open first filter element (28) containing a first solid beverage material (30). The second funnel (26) has second surfaces (152) adapted for carrying a closed second filter element (144) containing a second solid beverage material (146). A brewer unit (22) has a funnel-receiving area (54) sized to receive as an installed funnel, one at a time, both the first funnel and the second funnel. The unit has a water inlet (70). A heater (72) is coupled to the water inlet for heating received water. A water outlet (74) is coupled to the heater to deliver heated water to the installed funnel.

### BACKGROUND OF THE INVENTION

The invention relates to brewed beverages. More particularly, the invention relates to brewing systems for brewing multiple beverage types and/or volumes.

The most common forms of coffee brewers utilize open paper filters into which coffee grounds are placed. Exemplary filters are conical or generally frustoconical (e.g., with a pleated sidewall so that the filter may be formed from flat stock). The filter may be placed in a brew chamber (typically a removable brew funnel). The user may scoop a desired amount of coffee grounds into the filter and install the funnel on the brewer. Heated water is then discharged through the open top of the filter to directly contact the grounds. The water flows through the grounds and then passes through the filter and into a carafe, having acquired flavor and other components from the grounds.

Often, however, it is desired to brew different amounts of coffee. U.S. Pat. No. 6,465,035 of Knepler discloses a brew funnel having a selector settable to indicate a desired batch size and type of coffee. Sensors on an associated coffee grinder and on an associated coffee brewer then sense the setting to grind an appropriate amount of grounds and brew an appropriate amount of coffee.

Additionally, various closed filters have been developed wherein the filter completely encloses an amount of coffee grinds to form a cartridge. In cartridge brewers, the heated water will typically flow into the cartridge through one portion of the filter, pass through the grounds, and exit another portion of the filter. U.S. Pat. No. 6,345,570 of Santi and U.S. patent application Ser. No. 10/921,683 of Kief identify single cup brewers using generally circular coffee pods. U.S. patent application Ser. No. 10/969,265 of Kief identifies a funnel having an insert for carrying a coffee cartridge to improve flow through the cartridge.

### SUMMARY OF THE INVENTION

Accordingly, one aspect of the invention involves a brewing system having first and second structurally different funnels. The first funnel has surfaces adapted for carrying an upwardly open first filter element containing a first solid beverage material. The second funnel has second surfaces adapted for carrying a closed second filter element containing a second solid beverage material. A brewer unit has a funnel-receiving area sized to receive as an installed funnel, one at a time, both the first funnel and the second funnel. The unit has a water inlet. A heater is coupled to the water inlet for heating received water. A water outlet is coupled to the heater to deliver heated water to the installed funnel.

In various implementations, a valve may be coupled between the water inlet and outlet to control a delivery of the heated water. A sensor may be positioned to engage at least one of the first funnel and second funnel when said one is the installed funnel. A controller may be coupled to the sensor to receive an input. The controller may be coupled to the at least one valve to control operation of the valve to cause a discharge of the heated water in an amount associated with the installed funnel and different from an amount associated with the other funnel. The second funnel may have a depending cup holder having a support surface positioned to be spaced above a heating surface of the main unit when the second funnel is installed.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a brewing system.

FIG. 2 is a partially schematic view of a water delivery subsystem of the system of FIG. 1.

FIG. 3 is a view of a single serving funnel assembly for the system of FIG. 1.

FIG. 4 is a partially exploded view of the funnel assembly of FIG. 3.

FIG. 5 is a partial longitudinal cut-away view of the funnel assembly of FIG. 3 in an uninstalled condition.

FIG. 6 is a longitudinal cut-away view of the funnel assembly of FIG. 3 in an installed condition.

FIG. 7 is a view of a cup holder portion of the funnel assembly of FIG. 3.

Like reference numbers and designations in the various drawings indicate like elements.

### DETAILED DESCRIPTION

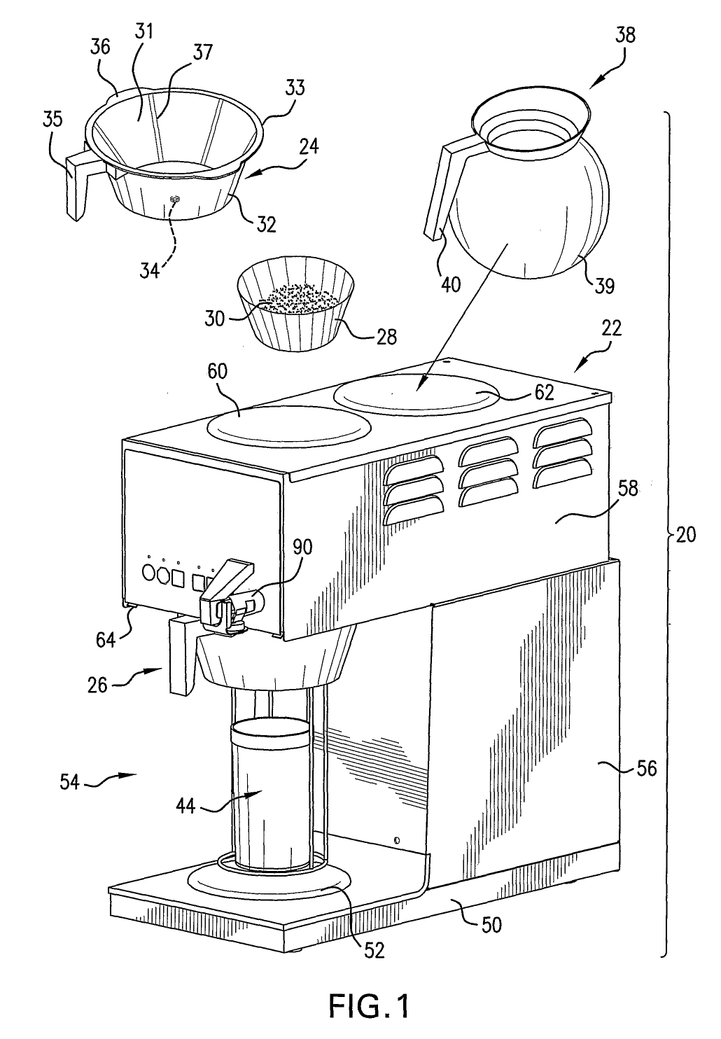

FIG. 1 shows a brewing system 20 having a main unit 22 to which either a first funnel 24 or a second funnel 26 may be installed. The first funnel 24 may be one of a number of conventional funnel configurations or other configurations for use with an open-top filter 28 containing grounds 30. An exemplary funnel 24 may be made as a unitary one-piece plastic molding. The exemplary funnel 24 includes a body 32 having an upper rim 33 and a lower drain aperture 34. A cantilevered handle 35 may extend from the body. An upper flange or a pair of side rails 36 may serve to mount the funnel in an installed position on the main unit (described below). A plurality of ribs 37 may space the filter 28 apart from a main interior surface 31 of the body 32 to facilitate flow of water through the filter.

The first funnel 24 may be used to fill a decanter/carafe 38. An exemplary carafe includes a glass body 39 and a plastic or metal handle 40. The second funnel 26 may be used to fill a single serving cup 44. The second funnel 26 may be configured for use with a single serving coffee pod (described below). Exemplary carafe sizes are typically in excess of 0.5 liter, more particularly, 1.5-6.6 liters. Exemplary single serving cup sizes are typically less than 1.0 liter, more typically, 0.15-0.7 or 0.2-0.5 liter. Exemplary amounts of coffee filling such carafes or cups may be close to such nominal capacities (e.g., 80-100%).

The basic form of the main unit 22 may be one of any of a number of existing or yet-developed forms. The exemplary form includes a base 50, generally elongate front-to-back. At the front, the base 50 bears a heating plate element 52 below an open brewing area or bay 54. A back 56 extends upward from a rear portion of the base 50. A top 58 extends from an upper end of the back over the brewing bay 54. The exemplary top includes front and back additional heating plate elements 60 and 62 for supporting filled or partially filled carafes and maintaining a desired coffee temperature. One or more of the various heating elements 52, 60, and 62 may be switchable on/off when it is not desired to heat on such element. A pair of side rails 64 along the top at the upper end of the brewing bay 54 may support the side rails or flange of an installed funnel, permitting installation by an essentially rearward translation of the funnel.

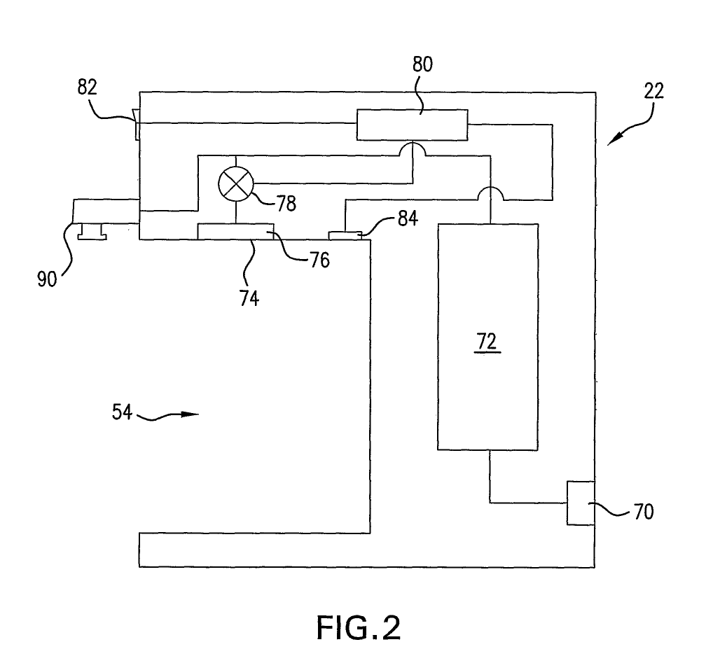

FIG. 2 schematically shows the unit 22 as including a water inlet 70 coupled to a water heater 72. The heater 72 is, in turn, coupled to a first outlet 74 located at a top of the brewing bay 54. As is discussed in further detail below, the exemplary outlet 74 may be formed as a plurality of outlet apertures in a brew/spray head 76. Flow of heated water to the head 76 is controlled by a valve 78. The valve 78 may, in turn, be controlled by a control unit 80 (e.g., a microcontroller). As is discussed below, the control system 80 may receive input from one or both of a user interface 82 (e.g., a switch array, control panel, or the like) and a funnel sensor 84. One or more additional outlets (e.g., a spigot 90) may be coupled to the water heater 72. For simplicity of illustration, power connections, and connections between the control unit 80 and the heating plate elements are not shown in FIG. 2.

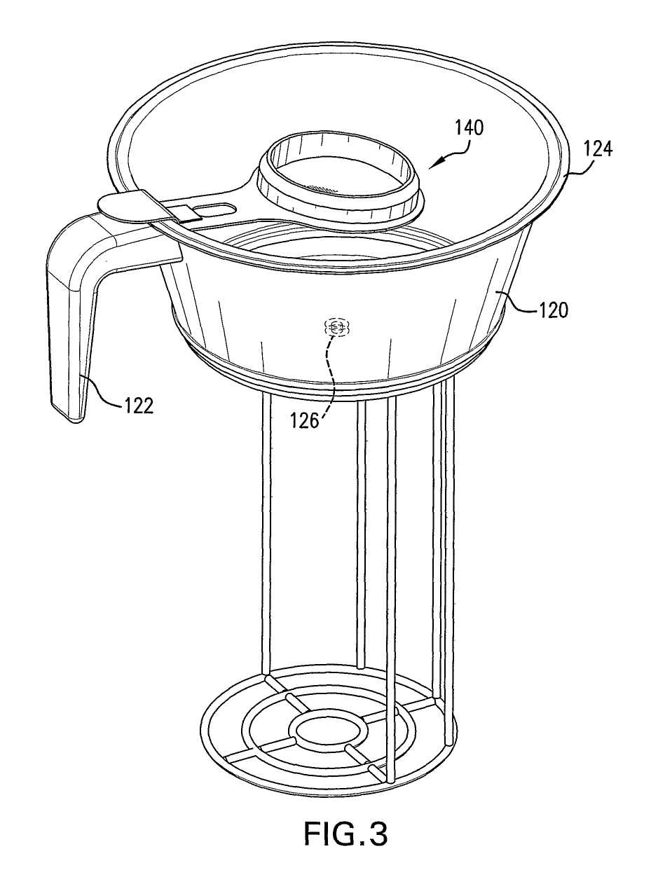

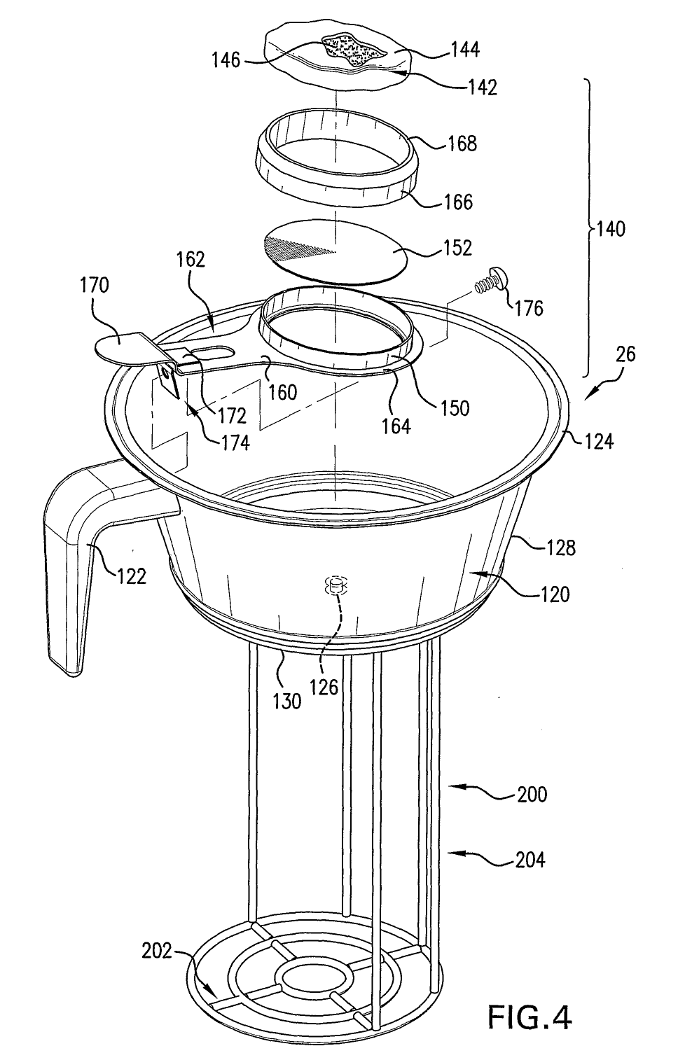

FIG. 3 shows further details of the second funnel 26. A main body 120 may be made of metal (e.g., stamped from stainless steel) welded or fastener-secured to a cantilevered handle 122 (e.g., also of stainless steel or of molded plastic). Alternatively, the main body may be made as a unitary plastic (e.g., polypropylene) molding along with a cantilevered handle 122. The exemplary body 120 extends from an upper flange 124 to a lower drain aperture 126. A sidewall 128 of the body is generally frustoconical and extends from an inboard aperture of the flange 124 to a base 130 in which the aperture 126 is formed. The second funnel 26 further includes a pod carrier assembly or insert 140 for carrying a single serving coffee pod 142 (FIG. 4). An exemplary pod 142 has a generally circular planform and includes a closed paper filter element 144 containing an amount of coffee grounds 146. The exemplary pod carrier 140 includes a sidewall (e.g., circular metallic cylindrical sleeve) 150 and a foraminate bottom wall 152 (e.g., a perforated metallic spray disk inserted within the sidewall 150 and retained by a lower shoulder or inwardly-directed lip). The exemplary sidewall 150 is secured to a driven end 160 of a lever arm 162 (e.g., metallic). In the exemplary embodiment, a distal perimeter portion 164 of the driven end 160 extends beyond an outer diameter of the sidewall 150 and carries a resilient elastomeric gasket or seal 166 (e.g., silicone) surrounding the sidewall 150 and having an upper end/rim 168 protruding above an upper end/rim of the sidewall 150.

The lever 162 has a driving end 170. As a fulcrum, a first portion 172 of a hinge (e.g., a metallic assembly) is secured to the lever arm (e.g., by welding). A second portion 174 of the hinge is secured to the funnel body 120 (e.g., by a metallic screw or other fastener 176, which may also secure the handle to the body). Exemplary metallic components of the pod carrier 140 are formed of a food-compatible stainless steel sheet stock.

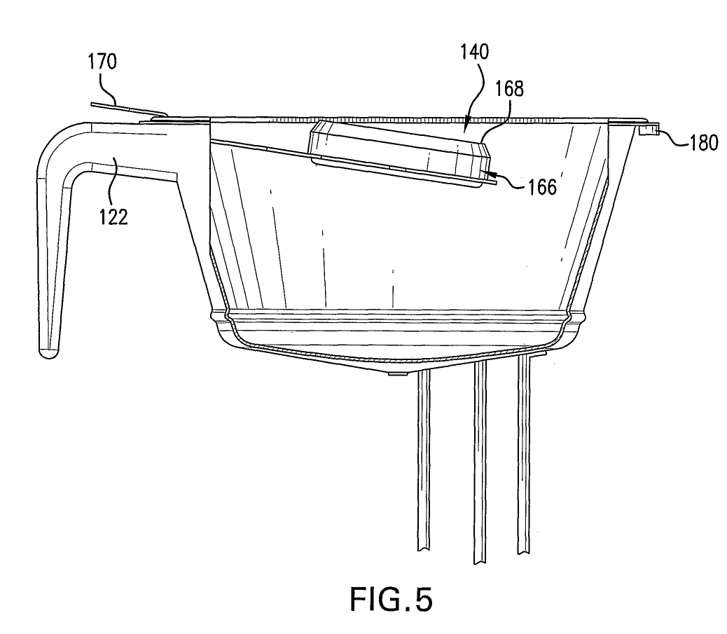

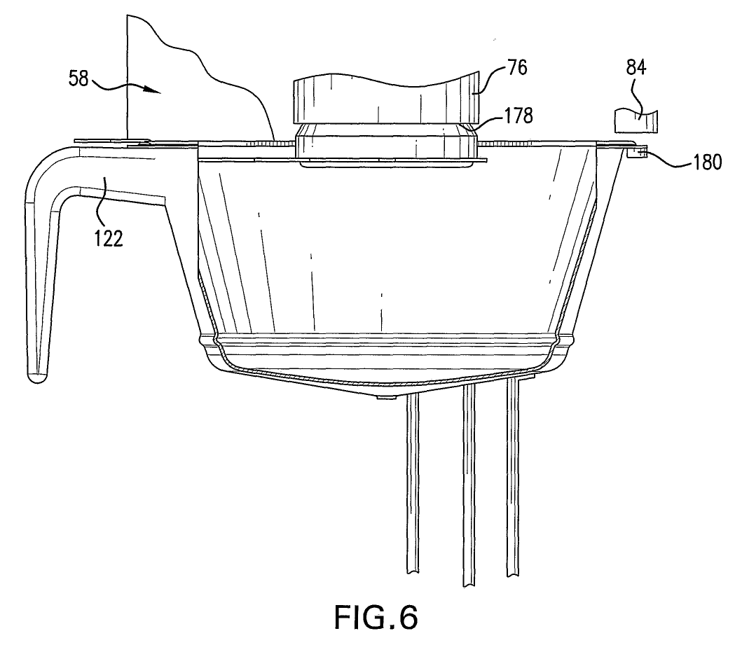

FIG. 5 shows the pod carrier 140 in an initial lowered position such as when the second funnel 26 is disengaged from the main unit 22. Upon insertion, however, the upper surface of the driving end 170 will come into contact with an underside of a forward portion of the top 58 of FIG. 1. With the final stage of insertion, this contact drives the driving end 170 downward and the driven end 160 upward, rotating the lever about a transverse fulcrum/hinge axis and bringing the pod carrier into an engaged orientation (FIG. 6) wherein the upper rim 168 of the seal 166 engages a complementary lower annular perimeter portion 178 of the head 76 that acts as seat. The seal 166 advantageously has appropriate resilience and sufficient engagement force to be effective to seal against temporary peak pressures locally within the chamber formed by the carrier, head, and seal as water is introduced and forced through the pod. Exemplary peak pressures may be 1-30 psig (7-200 KPa), more narrowly 2-10 psig (14-70 KPa). Alternative pod carriers may utilize more complex linkages to engage/disengage the carrier from the head (e.g., with multiple pivot axes, virtual pivot axes, and/or shifting pivot axes).

FIG. 6 also shows an identification element 180 (e.g., a magnet) mounted to the body substantially opposite the handle 122 (e.g., 180°±45°). Upon insertion, the identification element 180 interacts with the sensor 84, indicating to the control unit 80 that the second funnel 126 is in place and that the corresponding amount of water is to be dispensed from the head 76. To account for absorption, the amount of water dispensed from the head may be slightly greater than the desired amount of coffee to be dispensed (e.g., closer to but typically less than the carafe or cup capacity).

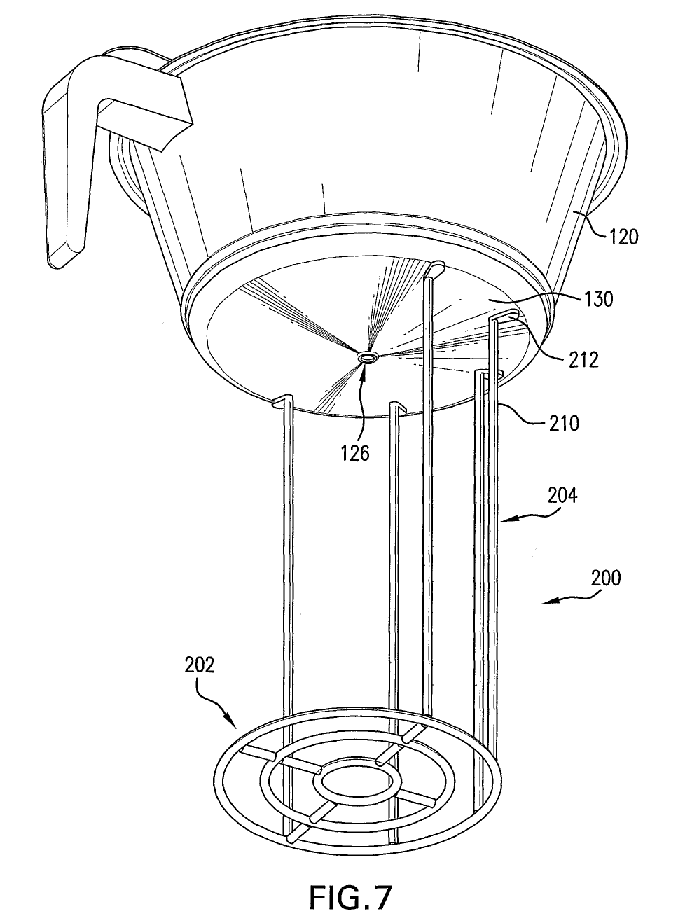

FIGS. 3 and 7 show further details of an exemplary cup holder 200 depending from the funnel body 120. The exemplary cup holder 200 includes a platform 202 for supporting a base of an associated cup below the aperture 126. A connecting portion 204 suspends the base from the funnel body. The raising provided by the cup holder 200 may serve one or more of several functions. It may bring the cup closer to the drain aperture to reduce splashing/spattering. It may prevent the cup from being heated by the heating plate element 52 (particularly significant with paper or foam cups). By not trapping coffee, it may keep the bottom of the cup clean relative to placing of the cup on the heating plate element. The exemplary cup holder 200 is metallic (e.g., formed of cut/bent/welded stainless steel wire). In this example, the connecting portion 204 is formed by a plurality of generally vertically-extending wires 210 having flattened/bent upper ends 212 welded to the base 130. Other constructions are possible.

One or more embodiments of the present invention have been described. Nevertheless, it will be understood that various modifications may be made without departing from the spirit and scope of the invention. For example, various aspects of the system may be implemented in remanufacturing an existing system or reengineering a configuration of such a system. In such situations, details of the existing configuration will influence or dictate details of any particular implementation. Various features such as the cup holder may be independently implemented or not implemented at all. Thus, for example, the cup holder may be made a nondestructively removable accessory on funnels such as that shown in U.S. Pat. No. 6,345,570 or others. Beverages other than coffee may be brewed (e.g., tea from tea leaves in a tea filter pod or beverages from dehydrated crystalline or other concentrate). Accordingly, other embodiments are within the scope of the following claims.

What is claimed is:

1. A brewing system (20) comprising:
a first funnel (24) having one or more first surfaces (31, 37) positioned for carrying an upwardly open first filter element (28) containing a first solid beverage material (30);
a second funnel (26), structurally different from the first funnel, the second funnel having one or more second surfaces (152) adapted for carrying a closed second filter element (144) containing a second solid beverage material (146); and
a brewer unit (20) having:
a funnel-receiving area (54) sized to receive as an installed funnel, one at a time, both the first funnel and the second funnel;
a water inlet (70);
a heater (72) coupled to the water inlet for heating received water; and
a water outlet (74) coupled to the heater to deliver heated water to the installed funnel.

2. The system of claim 1 wherein:
the main unit further comprises:
at least one valve (78) coupled between the water inlet (70) and outlet (74) to control a delivery of the heated water;
a sensor (84), positioned to engage at least one of the first funnel and second funnel when said one is the installed funnel; and
a controller (80) coupled to the sensor to receive input and to the at least one valve to control operation of the at least one valve to cause discharge of said heated water in an amount associated with the installed funnel and different from an amount associated with the other of the first and second funnel.

3. The system of claim 1 wherein:
the first funnel consists essentially of molded plastic; and
the second funnel comprises a molded plastic body (120) and a metallic insert (140).

4. The system of claim 1 wherein:
the main unit has a heating surface (52) below the water outlet; and
the second funnel has a depending cup holder having a support surface positioned to be spaced above the heating surface when the second funnel is installed.

5. An apparatus (22) comprising:
a water inlet (70);
a heater (72) coupled to the water inlet for heating received water;
means (64) for receiving in a first operative position one at a time of a plurality of different funnels (24; 26);
a water outlet (74) coupled to the heater (72) to deliver heated water to an installed funnel in the first operative position; and
means (80, 84) for determining from a received funnel a particular volume of said heated water to dispense through such funnel.

6. The apparatus of claim 5 further comprising:
a first funnel of the plurality of funnels and having means for carrying an upwardly open first filter element containing a first solid beverage material; and
a second funnel of the plurality of funnels, structurally different from the first funnel, and having means for carrying a closed second filter element containing a second solid beverage material.

7. The apparatus of claim 5 wherein:
the outlet (74) is formed in a spray head (76) having an annular seat (172); and
at least one funnel of the plurality of funnels has a pod carrier (140) having a resilient gasket (166) dimensioned to mate with the seat.

8. A method comprising:
installing a first funnel (24) to a brewer (22), the first funnel carrying an upwardly open first filter element (28) containing a first solid beverage material (30);
directing water through the first solid beverage material and first filter element to discharge from the first funnel as a first beverage;
removing the first funnel;
installing a second funnel (26), structurally different from the first funnel, to the brewer in place of the first funnel, the second funnel carrying a closed second filter element (144) containing a second solid beverage material (146); and
directing water through the second solid beverage material and second filter element to discharge from the first funnel as a second beverage.

9. The method of claim 8 wherein:
the first beverage is of a dissimilar composition to the second beverage.

10. The method of claim 8 wherein:
the first beverage is a coffee beverage and the second beverage is a tea beverage.

11. The method of claim 8 wherein:
the first beverage is dispensed in an essentially different amount than the second beverage.

12. The method of claim 8 wherein:
the installing of the second funnel brings the second filter element into contacting engagement with a water-delivery head (76).

13. The method of claim 12 wherein:
the first beverage is discharged into a carafe (38) having a capacity of more than 0.5 liter; and
the second beverage is discharged into a cup (44) having a capacity not more than 0.5 liter.

14. The method of claim 12 wherein:
the first beverage is discharged into a carafe (38) supported on a heating plate (52); and
the second beverage is discharged into a cup (44) supported above and spaced apart from the heating plate on a cup holder (200) depending from a body (120) of the second funnel.

15. The method of claim 8 wherein:
the first filter element is essentially conical, frustoconical, or pleated; and
the second filter element is an essentially a circular pod.

16. The method of claim 15 wherein:
the first beverage is discharged into a carafe having a capacity of more than 0.5 liter; and
the second beverage is discharged into a cup having a capacity not more than 0.5 liter.

17. The method of claim 8 wherein:
the installing of the first funnel functions to identify a first amount of water for brewing the first beverage; and
the installing of the second funnel functions to identify a second amount of water, different from the first amount, for brewing the second beverage.

18. A brewing funnel assembly (26) comprising:
a funnel body (120); and
a pod carrier (140) having a pod-holding portion (150, 152) and a mechanism (162, 174) coupling the pod holding portion to the funnel body and having a driving portion movable relative to the funnel body from a first condition to a second condition to shift the pod holding portion from a first position to a second condition.

19. The funnel of claim 18 wherein:
the pod carrier comprises a metal body having a foraminate base (152) and a sidewall (150); and
the shift includes a rotation.

20. The funnel of claim 18 further comprising:
a resilient seal (166) surrounding the sidewall.

21. The funnel of claim 18 further comprising:
a handle (122) secured to or unitarily formed with the funnel body; and
a magnet (180) carried by the funnel body substantially opposite the handle.

22. The funnel of claim 18 further comprising:
a cup holder (200) suspended from the funnel body.

23. The funnel of claim 22 in combination with:
a cup (44) carried by the cup holder (200).

24. A brewing funnel assembly comprising:
a funnel body (120);
a pod carrier (140) carried by the funnel body; and
a cup holder (200) suspended from the funnel body.

25. The funnel assembly of claim 24 further comprising:
a handle (122) extending from the funnel body;
a coffee pod (142) carried by the pod carrier; and
a cup (44) carried by the cup holder.

26. The funnel assembly of claim 24 wherein:
the cup holder is nondestructively removable and replaceable.
